(19) United States
(12) Patent Application Publication
(10) Pub. No.: US 2012/0084004 A1
(43) Pub. Date: Apr. 5, 2012

(54) DEVICE FOR STORING THE PATH FOLLOWED BY A BEARER

(75) Inventors: Jean-Marc ALexandre, Verrieres-Le -Buisson (FR); Gérard Chalubert, Voisins Le Bretonneux (FR); Sylvie Lamt-Perbal, Chatenay-Malabry (FR)

(73) Assignee: COMMISSARIAT AL'ENERGIE ATOMIQUE ET AUX ENERGIES ALTERNATIVES, Paris (FR)

(21) Appl. No.: 13/260,629

(22) PCT Filed: Mar. 24, 2010
(86) PCT No.: PCT/EP2010/053859

§ 371 Date: Dec. 16, 2011

(30) Foreign Application Priority Data
Mar. 27, 2009 (FR) 0901504
Sep. 18, 2009 (FR) 0956441

(51) Int. Cl. G01C 21/00

(52) U.S. Cl. 701/527

(57) ABSTRACT

A device for storing a path followed by a bearer, notably to guide a person. The device includes a set of sensors with which the bearer can be equipped, capable of at least giving a measurement of distance covered by the bearer and a measurement of change of heading made by the person; and means of processing the measurements performed by the set of sensors, said processing means creating and storing a metric graph representing the path followed by the bearer, said graph being formed by a set of nodes, a node consisting of at least one event detected by the set of sensors at a point on the path and of a link indicating a measurement of distance and of heading relative to the preceding node covered by the bearer, the first node of the graph being the starting point of the path.

The present invention relates to a device for storing the path followed by a bearer, notably to guide a person. It is applied, for example, to guiding people on the outward or return journey along a duly stored path.

Numerous activities require knowledge of the location of people within buildings or edifices, or even in other public or private places. Civil protection operations may require this type of location of people, for example to guide firefighters.

In this type of application, one general problem to be resolved is the development of sensor equipment complemented with processing algorithms that make it possible to perform a metric position measurement in three dimensions (3D) of the person relative to his starting point and measure the 3D metric path covered to go from the starting point to the arrival point, where the person is. All these measurements must also be performed in real time. This issue in terms of equipment includes a number of difficulties.

A first difficulty is to resolve the problem inside unknown buildings, and therefore buildings without drawings, and therefore also without an initial point of reference for the metric measurements.

A second difficulty lies in the fact that any building may be involved. It is in fact necessary to be able to supply information that is usable, and in real time, concerning the position and the path covered by the person to be located for buildings for which no drawing is available and for which there has been no position-finding or learning of the premises. This means that there is no pre-equipment of the building that might facilitate the locating and guiding task.

A third difficulty lies in the fact that the device has to be borne by a person. It must therefore have little bulk and be light.

Finally, given that such a device is intended for applications for bulk and public markets, its cost must be low.

With regard to civil protection, and notably the guiding of firefighters in emergency operations, one known solution uses a physical Ariadne's thread which is unwound as the firefighter who is holding it advances. This device does not supply the location of the person but a guide for backtracking or bringing help. Moreover, the limits of such a device are the short distance permitted by the physical link used which consists of the trail-wire, the fragility of the trail-wire, the difficulty of running this trail-wire into all the places and the fact that it is impossible or very difficult to follow several firefighters.

A number of solutions are known for replacing this physical Ariadne's thread.

In an outdoor environment, a first solution uses a GPS system. However, in some highly urbanized areas, the coverage is not always completely assured. Inside a building, the GPS signals are no longer picked up and this solution is therefore inappropriate therein.

Inside buildings, the known solutions require these buildings to have equipment, this equipment notably comprising radio terminals, repeaters or sensors. One drawback of these solutions based on equipping buildings is their cost of installation and of maintenance, the number of relay terminals necessary being generally very high. Because of this, such equipment in all the existing buildings cannot be envisaged.

There are other technological solutions, but these are not very accurate or are inoperable. In particular, the techniques based on vision are not very robust. They are notably disturbed by lighting problems (darkness, night) or even by dust or smoke. They also require a computer with high computing power. The techniques based on inertial sensors make it possible to measure a 3D displacement but measure speeds or accelerations after a relatively short measurement time. The measurements are then affected by an error rendering the device unusable or inoperable.

Other systems allow for a simple location without providing the guidance function of an Ariadne's thread. Such is the case with the system described in U.S. Pat. No. 6,323,807 B1. The technique described is based on prior learning of the premises. The locating is then done by comparison between the set of values from the sensors of the learning base and the value of the sensors measured as the person advances. Such a system makes it possible to locate a person but not to guide him by notably indicating a path to be followed. In particular, the learning effectively allows a person to be located but does not make it possible to create a sophisticated navigation strategy that is comprehensible to the person because of the non-identification of the events and of the distances and of the nature of the links between the various nodes of the trail.

One aim of the invention is to overcome the above-mentioned drawbacks by proposing a solution that works inside all types of buildings that does not require preliminary equipping of the buildings, or learning of the premises. To this end, the subject of the invention is a device for storing a path followed by a bearer, this device comprising at least:
a set of sensors with which the bearer can be equipped, capable of at least giving a measurement of distance covered by the bearer and a measurement of change of heading made by the person;
means of processing the measurements performed by the set of sensors, said processing means creating and storing a metric graph representing the path followed by the bearer, said graph being formed by a set of nodes, a node consisting of at least one event detected by the set of sensors at a point on the path and of a link indicating a measurement of distance and of heading relative to the preceding node covered by the bearer, the first node of the graph being the starting point of the path.

The distance and heading measurement indications may be in three dimensions.

An event on the path is, for example, a change of heading made by the bearer, or else a local environment encountered on the path provoking a characteristic detection of all the sensors.

The measurement indications are, for example, numbers of steps covered by the bearer.

In another possible embodiment, measurement indications give the metric distance covered by the bearer.

The set of sensors includes, for example, at least one inertial unit capable of measuring a distance covered and a change of heading of the bearer.

The device includes, for example, a barometric sensor, capable of measuring a change of height, a magnetometer, capable of measuring a change of heading of the bearer and/or a temperature sensor.

Advantageously, the processing means include, for example, a function for guiding the bearer on the outward or return journey along the stored path, the bearer being guided by instructions computed by the processing means, these instructions indicating the path to be covered by giving at least indications of distance to be covered and of change of heading, the computation of the path to be covered defined according to identified intermediate objectives reached, these intermediate objectives corresponding to the nodes of the stored graph.

The bearer being a person, the instructions are, for example, given to him by means of a human-machine interface.

The instructions may be accompanied by environmental information relating to the path, such information being supplied at certain nodes of the graph including events characteristic of the local environment.

When an event of a node of the graph has not been detected after a given time following the detection of the event of the preceding node, an instruction is, for example, given to do a U-turn.

Other features and advantages of the invention will become apparent from the following description, given in light of the appended drawings which represent:

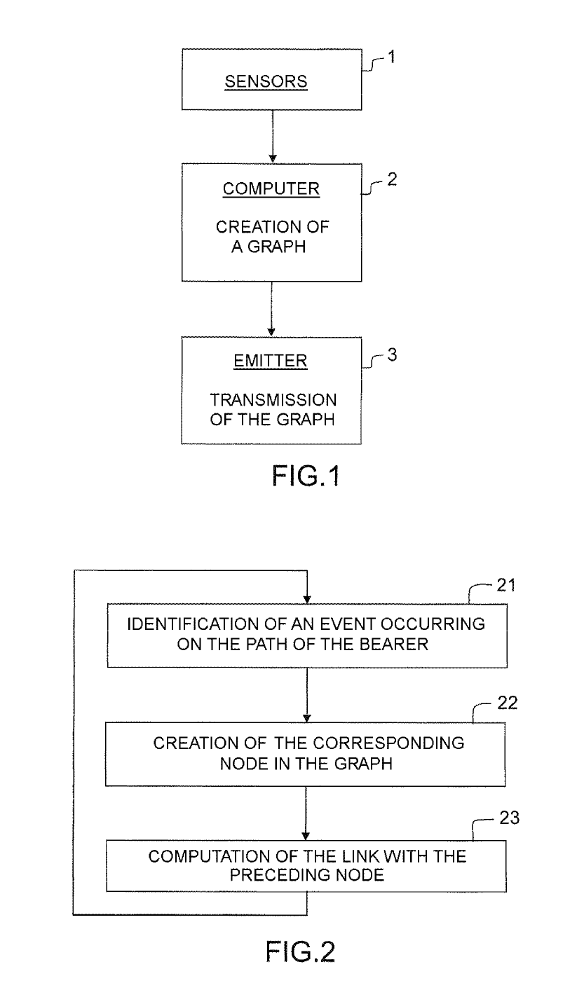

FIG. 1, components that can be used in a device according to the invention;

FIG. 2, an illustration of the process for creation of the nodes of a metric graph representative of the path followed by a bearer;

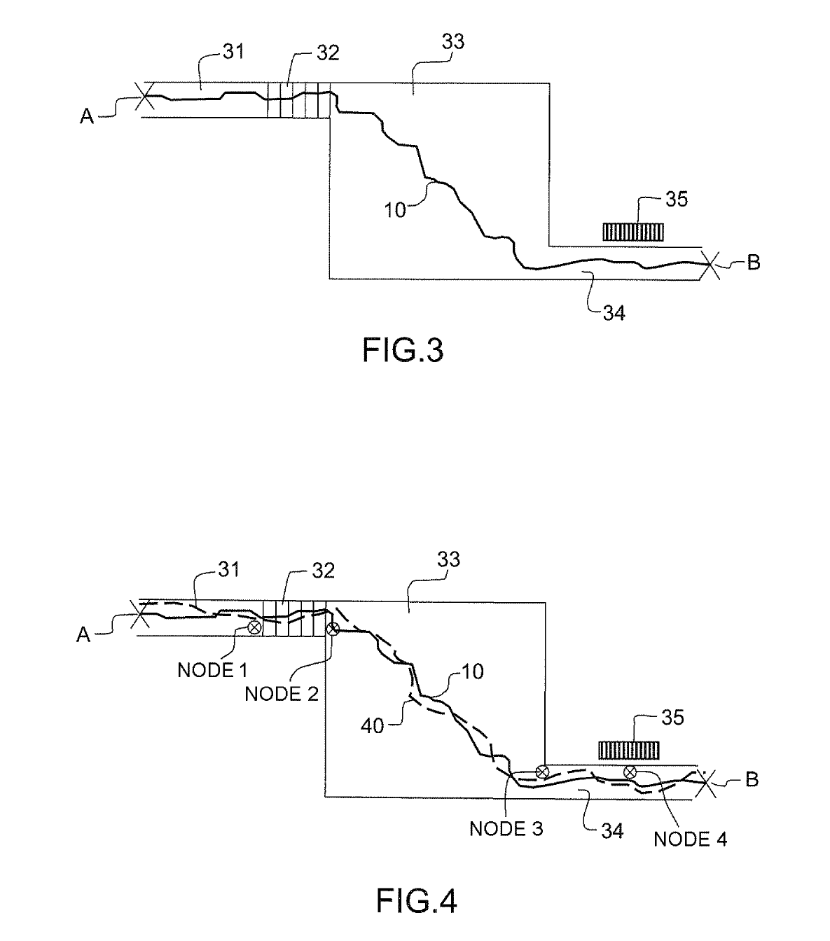

FIG. 3, an example of a path followed by a person inside a building;

FIG. 4, an example of a return path represented in light of the outward path of FIG. 3;

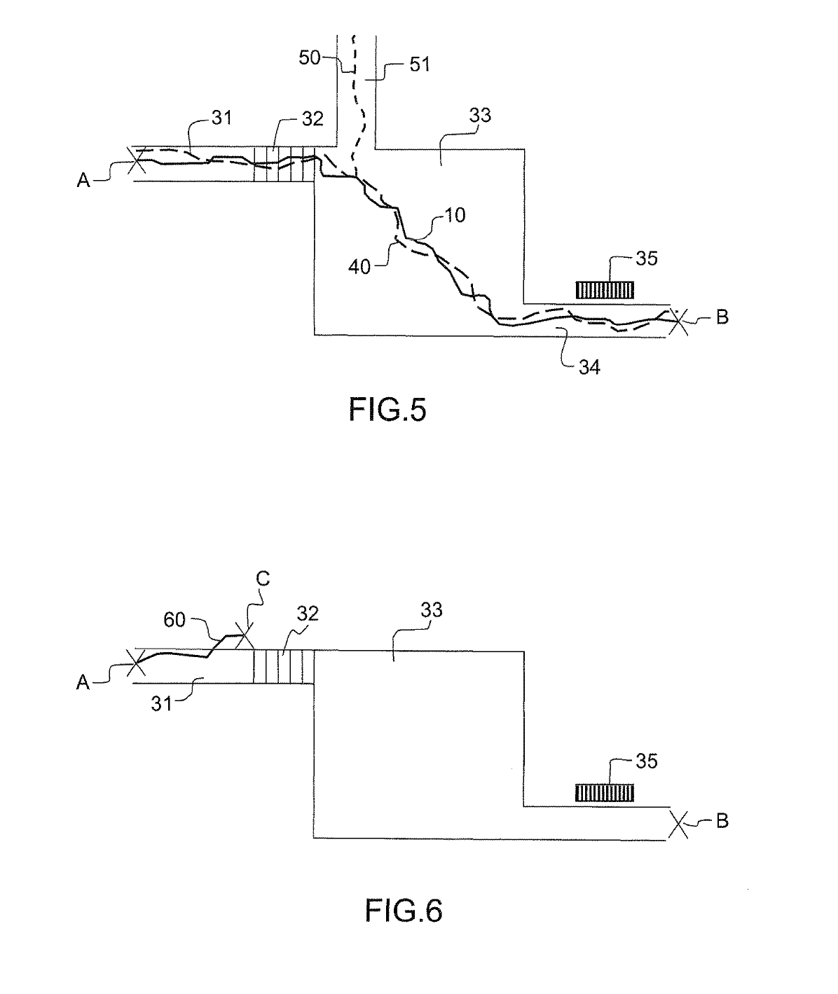

FIG. 5, an example of a return path including a path error;

FIG. 6, an example of the start of a path followed by a person meeting the person having covered the outward path.

FIG. 1 shows the components of a device according to the invention. Such a device includes at least a set of sensors 1 and processing means 2, for example a computer and its associated memories, these components 1, 2 equipping a moving bearer, for example a person. The computer 2 or any other equivalent processing means may be situated remotely from the person provided that the data picked up by the sensors can be transmitted to this computer.

The computer 2 creates a metric graph representative of the path followed by the bearer. This graph comprises a set of nodes each corresponding to a point on the path covered by the bearer. Each node includes distance information relative to a preceding node and heading information, and these basic information items may possibly be enriched with other information, notably environment information. A node is defined by means of the sensors 1 which detect the distance covered by the bearer and his change of heading. The distance and heading information items supplied by the sensors are in three dimensions. The duly constructed and stored graph can be used by the bearer himself to find his return path, or by another entity intended to find the bearer by using the same path. To this end, the graph may be transmitted by emission means 3, with which the bearer is, for example, equipped, to a remote reception center, situated outside the building in which the bearer is moving. The graph created by the computer 2 thus forms a virtual Ariadne's thread linking the bearer to his starting point.

Thus, the invention is notably based on the use of sensors 1 borne by a person, or any other type of bearer, these sensors being used to create the metric and angular graph of the movement of the person, in six dimensions (6D), that is to say in three position dimensions and three orientation dimensions. This graph makes it possible to locate, in real time and accurately, the position of the person in order to guide him, for a reverse path, or to guide other users to find him.

The sensors borne are at least a 3D accelerometer and a 3D gyrometer to determine the position and heading information. Other sensors may advantageously be borne to give the measurements precisely or enrich the information on the path represented by the graph. These other sensors are, for example, magnetometers, barometers, temperature or vision sensors. This list is not exhaustive.

The gyrometer and accelerometer sensors are used mainly to measure the distance covered in 6D. The principle may be as follows.

By combining the measurements supplied by these two sensors, the computer 2 estimates the trim, angle relative to the horizontal plane, of the gyrometer sensor. The computer then subtracts gravity from the accelerometer measurements. All that then remain are the accelerations specific to the movement of the person. By a double integration relative to time, the computer can estimate the displacement in 3D, that is to say the distance covered. To define the heading, the computer uses the measurements from the gyrometer. By time integration, it can estimate the angle of the direction taken by the person. The 3D combination of these two types of sensors, accelerometer and gyrometer, constitutes what is called an inertial unit.

These same sensors can identify a height difference and therefore detect, for example, a staircase or an elevator. An inertial unit may also be used to identify a placed foot and therefore count the number of steps. By positioning the inertial unit on the foot of the person, the computer can identify the placed foot phases, a placed foot phase corresponding to zero speed and acceleration measurements. These sensors can also identify an abrupt change of orientation corresponding to a change of heading in a corridor for example.

The magnetometers measure an orientation relative to the earth's magnetic field, like a compass function. They can be used to measure the heading in addition to the gyrometers. However, inside a building, there are many sources of magnetic pollution such as, for example, metal structures or computer screens. Advantageously, the magnetometer may therefore detect these sources of pollution and therefore position these sources in the graph. The latter is thus enriched with environment information, in this case of metallic type or more generally of disturbance source type disturbing measurements of the earth's magnetic field.

The barometers measure the atmospheric pressure. They can therefore accurately detect a height difference and therefore detect a change of floor for example. They can therefore advantageously be used to correct the inertial measurements of height which may drift over time. The accuracy of measurements obtained by the barometers can be as high as ten or so centimeters.

The temperature sensors can detect sources of heat on the path followed by the person, more generally temperature differences, helping to enrich the environment information of the graph. It is thus possible to detect radiators, or, conversely, cold regions.

The vision sensors provide another contribution to the environmental enrichment of the graph. The vision can also be used to measure distances and orientations. It is also makes it possible to detect simple visual events corresponding to dark or light rooms, or more complex visual events notably in the case of recognition of places or situations.

The set of sensors 1 with which a bearer is equipped therefore makes it possible to obtain a 6D graph representative of a path covered from an identified starting point which may advantageously be enriched with environmental information. The set of sensors 1 consists of at least one inertial unit consisting of a 3D accelerometer and a 3D gyrometer, or 3 accelerometers and 3 gyrometers positioned in the 3 directions of space. These basic sensors make it possible at least to determine the 6D graph. These six dimensions express that the graph includes position coordinates in 3D and angular, or heading, coordinates in 3D. The sensors, notably the gyrometers, accelerometers, are placed at points of the body which make it possible to obtain the most accurate or the most usable measurements. They may thus be placed on the legs or feet, arms or chest. They may also be placed at head level, incorporated, for example, in a headset with which the bearer is equipped.

All along the path that he pursues, the bearer makes spurious movements, typically head or arm movements, generally abrupt, or even more comprehensive movements when he turns around for example. The spurious movements generally have a substantially zero average longitudinal speed and an average angular speed which is also substantially zero. The computer has, for example, low-pass digital filters. Also, the device, based on speed and acceleration measurements, will necessarily commit distance and heading measurement errors; the filtering may be completed with distance and position corrections on particular events occurring in the path.

FIG. 2 illustrates the graph creation phases, repeated all along a path followed by the bearer. In a first phase 21, the device 1, 2 that is borne identifies, by means of the sensors 1, an event occurring on the path of the bearer, for example a change of heading. Since this change of heading is in 3D, it may be a change of direction to the right or left, but also upward or downward, typically embarking on a staircase. Then, in a second phase 22, the computer 2 creates a node corresponding to this event in the graph. Finally, in a third phase 23, the computer determines the link between this node and the preceding one, the link being the distance and the heading with the preceding node. These three phases 21, 22, 23 are reiterated all along the path as and when events are identified. All these event identifications are done automatically, without intervention on the part of the bearer.

Thus, as a person, or any other bearer, advances, the device borne by the person identifies in real time the events occurring on the path of the person. Between each node, a distance and heading measurement is performed.

The graph consists of nodes and links between these nodes. Each node of the graph is created according to events characteristic of the progress of the person inside the building.

A node of the graph corresponds to a signature characteristic of a place in the building. This signature detected by a sensor is equally characterized by a change of attitude of the person, change of heading on entering a corridor for example, and by an element characteristic of the place, the existence of a heat source for example. As an example, the following can therefore be cited:
abrupt change of heading measured by a magnetometer or by an inertial unit, making it possible to detect the entry into a corridor or into a room;
movement in a staircase by identification of tread height by means of an accelerometer sensor or a barometer;
movement in an elevator by recognition of a slow and continuous upward advance;
a heat source by a measurement of an abrupt temperature variation, characterizing a simple radiator or a fire depending on the intensity of the variation;
an event that cannot be identified by human beings such as an abrupt variation of the magnetic field notably characterizing the proximity of a metal structure.

The link between two nodes contains a quantity of information. It makes it possible in particular to link a node of the graph to the preceding node. It contains, for example:
the distance or the number of steps between two nodes;
the variation of heading between two nodes;
the nature of the link, for example upward or downward on a staircase, or upward or downward in an elevator.

The 3D path is measured between each node in order to add the metric dimension to the graph and better guide the person. However, a simpler solution, based on a measurement of the number of steps, is also possible. By measurement, whether metric or not, it is also possible to position the person relative to other operatives.

The orientation between each node makes it possible to define the heading to be followed. To simplify the system and make a graph easy to use for users, the reference headings are, for example, discretized into a finite number in order to give direction indications that are understandable to a person. The direction indications are, for example, indicated in 45° increments, bearing in mind that there are very few places where there are a multitude of directions to be taken, requiring a greater accuracy in the indication of the direction to be taken. Thus, in the case where an indication of directions in 45° increments is chosen, any heading variation between −22.5° and +22.5° is considered to be an advance in a straight line relative to a preceding measurement. Beyond that, a change of heading is estimated, 45° or 90° or 135°, etc., and a node is then created to identify this change of heading in the graph.

The graph created in this way can be used to guide the person on his return or to guide a person wanting to follow the same path, provided that the graph has been transmitted to that person, notably by the emission means 3 worn by the person. The graph can be used while it is being created. It can notably be used as soon as the person wants to go back for example. It is not limited in distance, neither shorter distances nor longer distances. It is also created automatically and instantaneously with respect to the user, which is why it can be used at any instant.

A use of the graph is notably described in the French patent application published under the number FR 2 918 745 concerning a device for assisting in the navigation of a person. The graph corresponds to the preexisting metric mapping used in this document to guide a person. The nodes of the graph can be likened to the intermediate objectives to be reached identified in this mapping.

Thus, as and when the nodes are reached, the user receives instructions to be guided, for example:
advance ten meters, or ten steps, in a straight line to reach a staircase;
go up one floor;
turn by an angle of 45° and advance 15 meters;
step over an obstacle.

These exemplary instructions illustrate how the person can be guided on his return path or how a person seeking to join that person can be guided. The computer used to create the graph may also include the program for interpreting the graph to guide the person.

The graph includes a concept of direction inasmuch as there is a starting point and an arrival point identified upon its creation. When the person, or more generally the bearer of the device according to the invention, sets out on the return path, the arrival point becomes the starting point and the instructions given are adapted to the return path, for example a change of direction to the left becomes a change of direction to the right for the return path. It involves a simple interpretation of the graph by the guidance device. When a person wants to join the bearer, his starting point is the starting point of the graph originally created. It is, if necessary, possible to join the path at a point situated after the starting point, for example in the middle of the graph or at any other intermediate point, by the recognition of a characteristic point of the path.

In real time, the device may indicate or correct the heading of the person to be guided. If the person commits an error and the device does not detect the next node of the graph, or detects an unidentified node in the outward path, the device can guide the person to return to the preceding node in order to resume the right path. FIGS. 3 to 6 show examples of use.

FIG. 3 shows an example of a path actually covered 10 by a person bearing a device according to the invention, between a starting point A and an arrival point B. The path 10 follows, from the point A, a corridor 31, approximately 10 meters long, then, at the end of the corridor, a staircase 32 comprising 5 treads ending in a hall 33 with a substantially square area, approximately 10 meters×10 meters. In the opposite corner, the path 10 continues by following a second corridor 34 at the end of which is situated the point B. The distance between the point B and the entry to the corridor is approximately 15 meters. A radiator 35 is situated on the left wall, in the direction of advance, at a distance of approximately 3 meters from the entry to the corridor 34.

A graph created by a device according to the invention, for a person covering the path 10, can thus be described by the nodes and the links described herein below.

The first node of the graph, node 0, corresponds to the starting point A.

The node 1 is created on detection of the staircase 32 by virtue, for example, of an inertial unit by means of a height and tread nose measurement. The link is created between the node 0 and the node 1 with distance information measured by the inertial unit. The measurement indicates 10 meters and the heading is estimated at zero although the path 10 that is followed is not perfectly rectilinear. As indicated previously, the computer includes a filtering algorithm cancelling small variations in heading.

The node 2 is created at the end of the staircase 32 and corresponds to a double event: end of staircase and change of heading. A link is created between the node 1 and the node 2 with distance information measured by the inertial unit and the number of treads detected.

The node 3 is positioned at the end of the hall 33 at the entry to the second corridor 34, based on the change-of-heading event. The link between the node 2 and the node 3 is a straight line of approximately 12 meters and a change of heading of 45° estimated by the inertial unit.

The node 4 is identified on passing the radiator 35 by virtue of a temperature sensor which detects its presence. The link between the nodes 3 and 4 is a straight line of 3 meters. In this example, an event characteristic of the path is a heat source. Other types of characteristic events may be detected, such as metal structures or light sources for example, and more generally any local environment encountered along the path which gives rise to a characteristic detection on the part of the sensors: abrupt change of temperature or brightness, variation of the earth's magnetic field, altitude variation, etc.

The node 5 is the end of the path, corresponding to the point B. The link between the node 5 and the node 4 is a straight line of 12 meters.

If D is used to denote the distance, the graph can be stored in the device by means of the following table:

| Nodes | Events | Links |
|---|---|---|
| 0 | Start | |
| 1 | Up staircase | D = 10 m, heading = 0° |
| 2 | End of up staircase | D = 2 m or 5 treads, heading = 0° |
| 3 | Change of heading | D = 12 m, heading = 45° |
| 4 | Heat source | D = 3 m, heading = 0° |
| 5 | Arrival | D = 12 m, heading = 0° |

This graph can be used in two ways. FIGS. 4 and 5 illustrate the guidance of a person for the return journey. FIG. 6 illustrates the case of guidance of a person joining the bearer.

FIG. 4 shows an example of a return path 40 identified with respect to the outward path 10 of FIG. 3. The nodes 1 to 4 identified in the graph have been represented with respect to these paths 10, 40, the nodes 0 and 5 respectively corresponding to the points A and B.

The information described herein below is, for example, indicated to the person from the point B:

From this point B, the device gives the instruction to advance straight ahead for 15 meters (or advance straight ahead for 12 meters then straight ahead for 3 meters after detection of a heat source). An inertial unit borne by the person measures, for example, the distance covered and the heading, then indicates in real time the remaining distance to the node 3 situated at the exit of the second corridor 34 opening out in the hall 33. On approaching this hall 33, on approaching the node 3, the device indicates to turn right by 45°. On detection of the radiator event, at the node 4 or the change-of-heading event, at the node 3, the device may be relocated relative to the stored graph if the position measurements are partially incorrect.

In the path in the hall 33, the device monitors the heading and indicates the distance to be covered in a graduated manner to the down staircase 5, at the node 2, and so on to the point A, the point of arrival for the return journey.

FIG. 5 illustrates an example in which the person commits a path error 50 by following a corridor 51 instead of taking the down staircase 32. After a distance of 12 meters for example, greater than the distance to cross the hall 33, the device then prompts the person to do a U-turn, because the expected event corresponding to the down staircase, node 2 of the graph, has still not been reached. On detection of the staircase 32, the device is relocated in the graph. If necessary, if the staircase 32 is not detected, the device gives the instruction to the person to continue to do a U-turn to the place corresponding to the preceding node, the node 3, to be relocated in the graph.

FIG. 6 illustrates a second possible use of the graph. This is the case in which another person wants to cover the same path, for example, to join the person at the point B. This person bears the same type of equipment, notably sensors, as the person having covered the first path 10. He or she is, for example, equipped with the same device as the first person, the device having in memory the graph created when the first person covered the path 10. To this end, the device includes, for example, reception means in order to receive then store the graph. If necessary, the graph may be received by other reception means then transmitted to the guidance device by any communication medium. The graph is transmitted by radio wave, for example as the first person advances or at any instant on a command from this person, or automatically, for example on creation of each node. Advantageously, it is not necessary to provide complex or powerful radio communication means, because the transmission band can be narrow given the low transmitted information bit rate. The useful range inside a building can thus be very great and easily as much as several hundred meters for example.

From the point A, the device indicates to advance to the node 1, corresponding to the start of the staircase. The device therefore indicates to advance 10 meters in a straight line to the staircase. A line 60 illustrates a path corresponding to the measurement of the sensors borne by the second person, joining the preceding person, this path 60 linking the starting point A to a point C. FIG. 6 illustrates an example in which an estimation error is committed, the position of point C being situated outside the corridor 31. At this point C, the inertial unit has detected a staircase. The device then realigns the position of the person in the graph with the node 1 and gives indications to go to the node 2, and so on to the arrival point B by combining distance and heading measurements, by relocating the person on the nodes of the graph and by guiding said person on the path.

An exemplary application has notably been described to guide a person, a firefighter for example, in a civil protection operation. The invention can also be applied to bearers of the device other than persons. It may, for example, be applied to guide robots or any other mobile bearers.

1. A device for storing a path followed by a bearer, the device comprising:
a set of sensors with which the bearer can be equipped, capable of at least giving a measurement of distance covered by the bearer and a measurement of change of heading made by the person; and
means of processing the measurements performed by the set of sensors, said processing means creating and storing a metric graph representing the path followed by the bearer, said graph being formed by a set of nodes, a node consisting of at least one event detected by the set of sensors at a point on the path and of a link indicating a measurement of distance and of heading relative to the preceding node covered by the bearer, the first node of the graph being the starting point of the path.

2. The device according to claim 1, wherein the distance and heading measurement indications are in three dimensions.

3. The device according to claim 1, wherein an event on the path is a change of heading made by the bearer.

4. The device according to claim 1, wherein an event on the path is a local environment encountered on the path provoking a characteristic detection of all the sensors.

5. The device according to claim 1, wherein the measurement indications are numbers of steps covered by the bearer.

6. The device according to claim 1, wherein the measurement indications give a metric distance covered by the bearer.

7. The device according to claim 1, wherein the set of sensors includes an inertial unit capable of measuring a distance covered and a change of heading of the bearer.

8. The device according to claim 1, further comprising a barometric sensor capable of measuring a change of height.

9. The device according to claim 1, further comprising a magnetometer capable of measuring a change of heading of the bearer.

10. The device according to claim 1, further comprising a temperature sensor.

11. The device according to claim 1, further comprising means for transmitting the graph.

12. The device according to claim 1, wherein the processing means include a function for guiding the bearer on the outward or return journey along the stored path, the bearer being guided by instructions computed by the processing means, these instructions indicating the path to be covered by giving at least indications of distance to be covered and of change of heading, the computation of the path to be covered being defined according to identified intermediate objectives reached, these intermediate objectives corresponding to the nodes of the stored graph.

13. The device according to claim 12, wherein
the bearer is a person, and
the instructions are given to the bearer by means of a human-machine interface.

14. The device according to claim 12, wherein the instructions are accompanied by environmental information relating to the path, such information being supplied at certain nodes of the graph including events characteristic of the local environment.

15. The device according to claim 12, wherein when an event of a node of the graph has not been detected after a given time following the detection of the event for the preceding node, an instruction is given to do a U-turn.
